(19) United States
(12) Patent Application Publication
(10) Pub. No.: US 2015/0214992 A1
(43) Pub. Date: Jul. 30, 2015

(54) ELECTRONIC DEVICE COVER

(71) Applicants: Nicholas J.S. Gant, Henderson, NV (US); Kathleen Gant, Henderson, NV (US)

(72) Inventors: Nicholas J.S. Gant, Henderson, NV (US); Kathleen Gant, Henderson, NV (US)

(21) Appl. No.: 14/678,703

(22) Filed: Apr. 3, 2015

Related U.S. Application Data
(63) Continuation-in-part of application No. 13/719,173, filed on Dec. 18, 2012, now abandoned.

(51) Int. Cl. H04B 1/3888; H04M 1/18

(52) U.S. Cl. CPC H04B 1/3888; H04M 1/185

(57) ABSTRACT

An electronic device cover provides a slot that allows a hand to orient the electronic device to a desired angle. The cover includes a housing for at least partially enclosing the electronic device. The housing includes an inner surface for engaging the electronic device. An outer surface provides protection to the electronic device. The outer surface joins with a slot from a rear end of the cover. The slot is configured to be operable to allow at least part of a hand to at least partially enter. The hand positions parallel between the slot and the outer surface. A snug fit allows for enhanced control and grip of the electronic device. The hand turns to orient the electronic device to a desired angle for operating and viewing. The hand turns to reorient the electronic device to a horizontal position for better viewing of videos. The slot uses accordion seams.

### CROSS-REFERENCE TO RELATED APPLICATIONS

The present continuation-in-part patent application claims priority benefit of the U.S. patent application Ser. No. 13/719,173 entitled “ELECTRONIC DEVICE COVER”, filed on 18 Dec. 2012 under 35 USC 111(a), which is hereby incorporated by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to covers. More particularly, one or more embodiments of the invention relate to an electronic device cover with an expandable, accordion-style slot that enables manipulation of an electronic device.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a portable electronic device is a personal, wireless electronic device with customizable communications, applications and entertainment capabilities.

One specific type of electronic communication device is a cell phone, or smart phone. The cell phone can make and receive telephone calls over a radio link while moving around a wide geographic area is a cell phone. Often, the phone contains sensitive electrical components that need to be protected with a casing or thick skin.

Often, a casing, holster, skin, or pouch is used to contain the phone. The covers are made of hard plastic or adhesive-backed vinyl pieces. The vinyl skins are often pre-cut to fit a cell phone or portable electronic device. This covering not only protects against shock, but also provides a decorative outer surface for the phone. The casing forms the portion of the phone that the hand generally engages when picking up, handling, and operating the phone.

It is known that, as cell phones become more prevalent, they are increasingly being carried by individuals that attempt to perform multiple duties with their hands while operating the phone, or do not carry wallets or purses, for example, children, teenagers, etc. These individuals typically carry their cells phones in their pants pockets, backpacks, or in their hand. They may also, however, need to perform duties with one hand while manipulating the cell phone.

Typically, cell phone covers are not configured in a manner that allows users to secure one or more fingers into the cell phone cover to prevent the cell phone from slipping out of the user's hand. This results in accidental droppings of the phone and limits what one can do with the hands while operating the phone.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective rear view of an exemplary electronic device cover, in accordance with an embodiment of the present invention;

FIG. 2 illustrates a detailed perspective front view of an exemplary electronic device cover, in accordance with an embodiment of the present invention;

FIG. 3 illustrates a detailed perspective rear view of an exemplary electronic device cover with a hand positioned inside an exemplary slot, in accordance with an embodiment of the present invention;

FIG. 4 illustrates a detailed perspective front view of an exemplary electronic device cover partially encapsulating an iPad with a hand positioned inside an exemplary slot, in accordance with an embodiment of the present invention;

FIG. 5 illustrates a detailed perspective front view of an exemplary electronic device cover partially encapsulating an iPhone with at least part of a hand positioned inside an exemplary slot, in accordance with an embodiment of the present invention;

FIG. 6 illustrates a detailed perspective rear view of an exemplary electronic device joined to an exemplary slot, in accordance with an embodiment of the present invention;

FIGS. 7A and 7B illustrate detailed perspective views of an exemplary cover, where FIG. 7A illustrates the cover in an expanded position, and FIG. 7B illustrates the cover in a stowed position, in accordance with an embodiment of the present invention;

FIG. 8 illustrates a close-up rear view of an exemplary accordion seam expanded away from the outer surface of the housing, in accordance with an embodiment of the present invention;

FIG. 9 illustrates a close-up rear view of an exemplary accordion seam compressed against from the outer surface of the housing, in accordance with an embodiment of the present invention;

FIG. 10 illustrates a perspective view of an exemplary vent portion in an exemplary open position to enable passage of air through the slot, in accordance with an embodiment of the present invention; and

FIG. 11 illustrates a close-up view of an exemplary vent portion in an exemplary closed position and an exemplary ridged edge along the length of the vent portion, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

There are various types of electronic device covers that may be provided by preferred embodiments of the present invention. In one embodiment of the present invention, the electronic device cover may provide a cover for a portable electronic device. In some embodiments, the cover may include a housing for at least partially enclosing the electronic device. The housing may include an inner surface for engaging the electronic device. The housing may further include an outer surface for providing protection to the electronic device. In some embodiments, the outer surface may join with at least one slot from a rear end of the cover. The at least one slot may be configured to be operable to allow at least part of a hand to at least partially enter. In some embodiments, the hand may position parallel between the slot and the outer surface. In this manner, a snug fit may allow for enhanced control and grip of the electronic device. In some embodiments, the hand may turn to orient the electronic device to a desired angle for operating and viewing.

Those skilled in the art, in light of the present teachings, will recognize that a display portion of the electronic device may be viewed in a horizontal position or a vertical position from a front end of the cover. The horizontal position may be more efficacious for viewing video content. The hand may turn to reorient the electronic device to the horizontal position for better viewing of videos on the display portion, including, without limitation, widescreen high definition video.

In some embodiments, the slot comprises a pair of ends that join with the outer surface of the housing. An accordion seam forms a junction between the outer surface and the pair of free ends. The accordion seam articulates between an expanded position and a stowed position. In the expanded position, the slot at least partially extends from the outer surface of said housing. In this manner, a hand or object may have greater space to fit into the slot. Furthermore, the generally resilient fabrication of the slot further increases the expansive capacity of the slot. In the stowed position, the slot at least partially compresses against the outer surface of the housing. The stowed position enables the slot to rest flush against the housing for facilitated stowage and portability.

In some embodiments, the slot may include a vent portion to enable passage of air and ventilate the object, such as a hand from behind the slot. The vent portion may include an elongated rectangular shape. However, other shapes are possible. The vent portion is disposed to move between an open position and a closed position. In one embodiment, the vent portion slides laterally across the slot. The vent portion may include a ridged edge along its length. The ridged edge is configured to facilitate sliding the vent portion between the open position and the closed position.

However, in other embodiments, the vent portion may detach, or pivot between the open position and a closed position. The open position is operable to at least partially enable passage of air through the slot. Conversely, the closed position is operable to at least partially restrict passage of air through the slot. In this manner, the hand will not be hot and uncomfortable while manipulating the communication device.

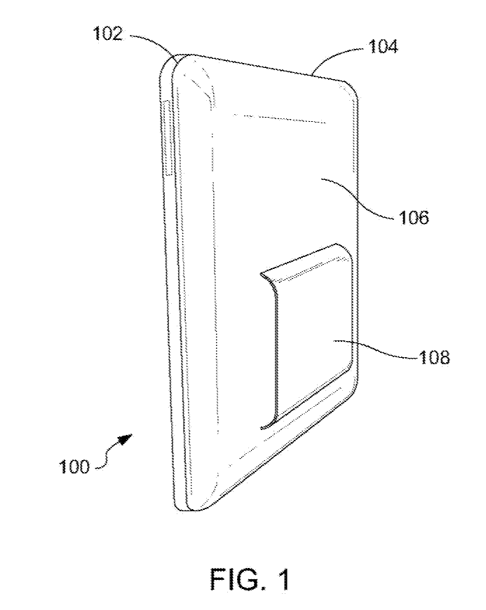

FIG. 1 illustrates a detailed perspective rear view of an exemplary electronic device cover, in accordance with an embodiment of the present invention. In the present embodiment, an electronic device cover 100 may provide a cover for a portable electronic device. The electronic device may include, without limitation, an iPad, an iPhone, a smartphone, and a portable electronic device. In some embodiments, the cover may include a housing 102 for at least partially enclosing the electronic device. The housing may include an inner surface for engaging the electronic device. The inner surface may be fabricated from rubber to help grip the electronic device.

The housing may further include an outer surface 104 for providing protection to the electronic device. The housing may be operable to provide shock resistance, whereby if dropped, the electronic device may be protected from damage. In some embodiments, the outer surface may join with a slot 108 from a rear end 106 of the cover. The slot may be configured to be operable to allow at least part of a hand to at least partially enter. In this manner, the hand may turn to orient the electronic device to a desired angle for operation and viewing.

In some embodiments, the slot may extend from a rear end of the cover. The slot may be configured to provide a snug fit for the hand. In one alternative embodiment, the slot may be adjustable to provide a snug fit to the hand. In yet another alternative embodiment, the slot may include an apertures for keeping the hand cool. The cover may be sized and dimensioned to at least partially cover the electronic device, including, without limitation, 115 mm×59 mm×9 mm. However, in other embodiments, the cover may include larger or smaller sizes. Suitable materials for fabricating the cover may include, without limitation, plastic, rubber, neophrane, high density polyurethane, metal, wood, and fiberglass.

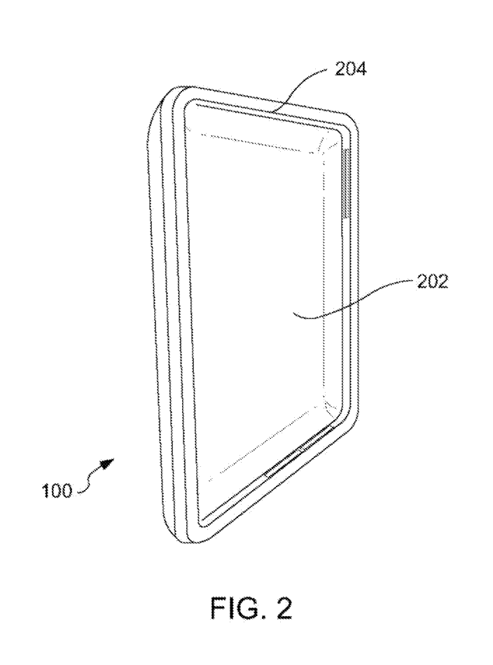

FIG. 2 illustrates a detailed perspective front view of an exemplary electronic device cover, in accordance with an embodiment of the present invention. In the present embodiment, the housing may include a plurality of apertures that align with a jack, a port, a camera lens, and a display screen. In some embodiments, the display screen may secure within an inner surface 202 of the cover. The display screen may be viewable from a front end 204 of the housing through an aperture.

In some embodiments, the aperture for the display screen may include a size and dimension configured to confirm to a specific electronic device. For example, without limitation, a cover configured for an iPhone may have smaller apertures than a cover configured for an iPad. In one alternative embodiment, the cover may encapsulate cameras, laptops, and any device that requires orientation in a variety of angles for operation or viewing.

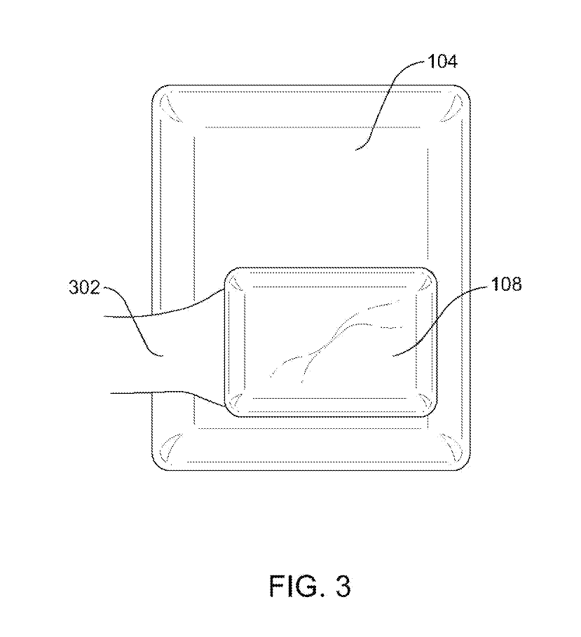

FIG. 3 illustrates a detailed perspective rear view of an exemplary electronic device cover with a hand positioned inside an exemplary slot, in accordance with an embodiment of the present invention. In the present embodiment, at least part of a hand 302 may position parallel between the slot and the outer surface. In this manner, a stable fit may allow for enhanced control and grip of the electronic device. In some embodiments, a user may utilize a desired amount of fingers to position inside the slot. Other suitable alternatives to a slot or pocket which may be used include, without limitation, an open-ended pocket that resembles a bracket. Some alternative embodiments may employ ring type cylinders for the individual insertion of the user's fingers through such cylinders. The hand may form a snug fit with the slot for orienting the cover to a desired angle. The desired angle may include, without limitation, a horizontal view, a vertical view, a front view, and a rear view.

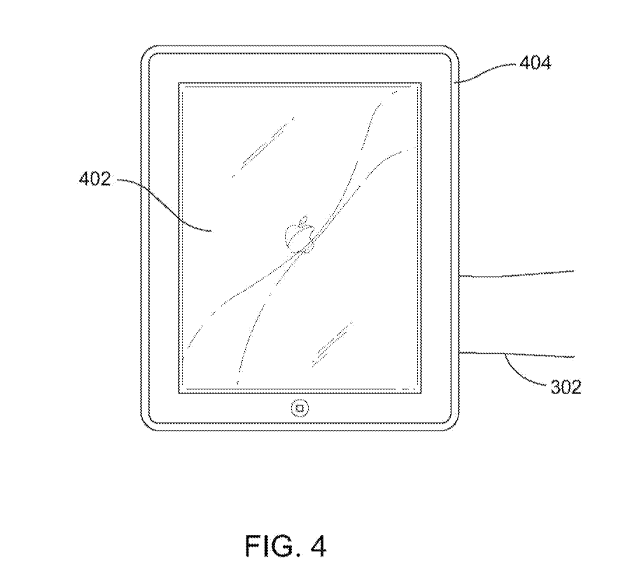

FIG. 4 illustrates a detailed perspective front view of an exemplary electronic device cover partially encapsulating an iPad with a hand positioned inside an exemplary slot, in accordance with an embodiment of the present invention. In the present embodiment, an electronic device 402 may position inside the cover. The electronic device may include a display portion. In some embodiments, the display portion may provide viewing through an aperture 404. The display portion may be viewed in a horizontal position or a vertical position from the front end of the cover. The horizontal position may be more efficacious for viewing video content. The hand may turn to reorient the electronic device to the horizontal position for better viewing of videos on the display portion, including, without limitation, widescreen high definition video.

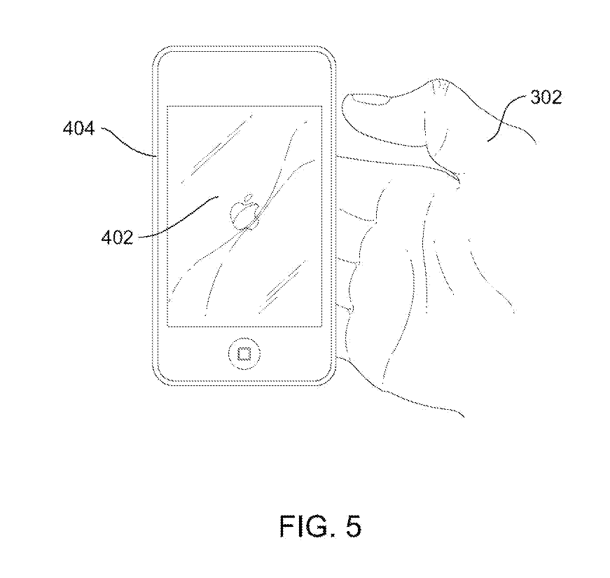

FIG. 5 illustrates a detailed perspective front view of an exemplary electronic device cover partially encapsulating an iPhone with at least part of a hand positioned inside an exemplary slot, in accordance with an embodiment of the present invention. In the present embodiment, the slot may receive part of a hand, or a complete hand, depending on the type and weight of the electronic device. For example, without limitation, a larger iPad may require a complete hand to support a greater weight, while a smaller, lighter iPhone may only require a few fingers to support the lesser weight. In one alternative embodiment, a foot may position inside the slot for orienting the electronic device.

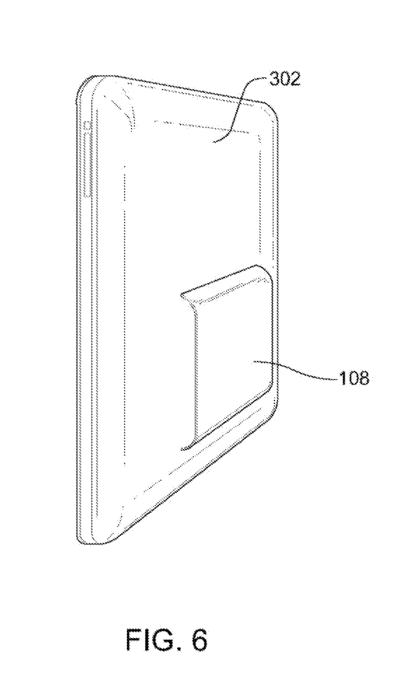

FIG. 6 illustrates a detailed perspective rear view of an exemplary electronic device joined to an exemplary slot, in accordance with an embodiment of the present invention. In the present embodiment, the slot may position directly on the electronic device. In this manner, the slot may be configured to be operable to allow at least part of a hand to at least partially enter from a rear end of the electronic device. In one alternative embodiment, the electronic device may include an integrated rubber surface for protection along with the slot, whereby the separate cover is not required.

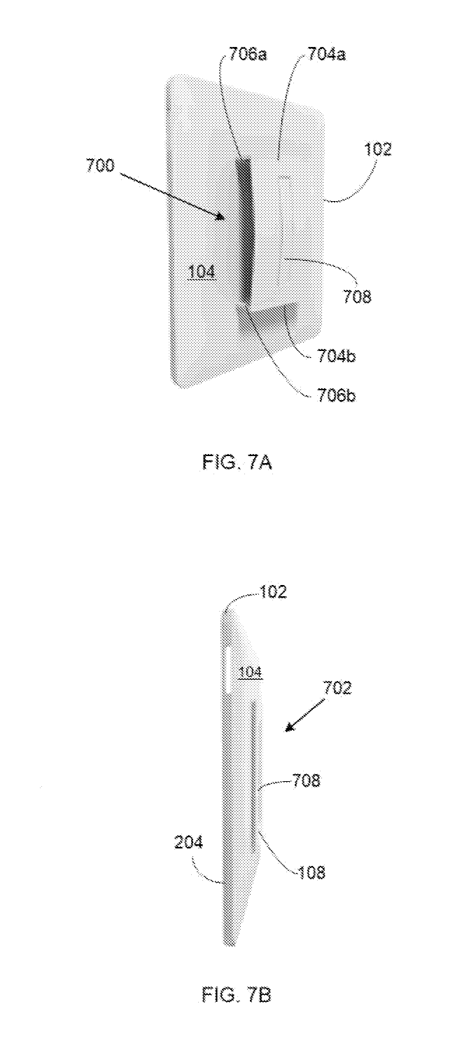

FIGS. 7A and 7B illustrate detailed perspective views of an exemplary cover, where FIG. 7A illustrates the cover in an expanded position, and FIG. 7B illustrates the cover in a stowed position. In one aspect, the slot expands and retracts through an accordion mechanism to create additional space for fitting and object, such as the hand, between the slot and the outer cover of the housing. The slot may also have a substantially resilient material composition that stretches to increase the space and retracts back against the housing when the object is removed. In this manner, the slot is adaptable for variously sized hands and also enhances comfort of the hand.

In one possible embodiment, fingers and/or hand slip behind the slot to enable one-hand support of the electronic device. The fingers and/or hand inserted into the slot provide complete and reliable support of the electronic device, while leaving one hand completely free in order to operate the electronic device. Furthermore, as discussed above, the housing may include a plurality of apertures, including all necessary ports to accommodate features on the electronic device, including, without limitation, camera lenses, charging ports, volume controls, headphone ports, and USB ports.

In some embodiments, the slot comprises a pair of ends 704a, 704b that join with the outer surface of the housing. The pair of ends form the terminus of the slot. In some embodiments, a pair of accordion seams 706a, 706b form a junction between the pair of free ends and the outer surface of the housing. The pair of accordion seams may fasten to the outer surface though various fastening mechanisms, including, without limitation, plastic molding, adhesives, welding, screws, and the like. In one embodiment, the slot orients vertically along the length of the housing. However, in other embodiments, the slot orients horizontally to the length of the housing.

The pair of accordion seams articulate between an expanded position 700 and a stowed position 702. In the expanded position, the slot at least partially extends from the outer surface of said housing. In this manner, a hand or object may have greater space to fit into the slot. Furthermore, the generally resilient fabrication of the slot further increases the expansive capacity of the slot.

In the stowed position, the slot at least partially compresses against the outer surface of the housing. The stowed position enables the slot to rest flush against the housing for facilitated stowage and portability. Those skilled in the art will recognize that if the slot did not lay almost flush then the housing, it would be too bulky to insert into a pocket or small purse which could make use of the cover inconvenient. Also, with the slot able to lay almost flush with the housing, the electronic device may rest flat on a table or other surface area. Finally, the slot may lie flat to ensure that the cover can be easily packaged, stacked, stored and/or shipped.

In some embodiments, the slot may include a vent portion 708 to enable passage of air and ventilate the object, such as a hand from behind the slot. The vent portion is effective for cooling the hand and also for providing a view of the hand from behind the slot. The vent portion may have any variety of widths and thicknesses, depending on the desired ventilation.

In some embodiments, the slot may be configured to accommodate both right and left handed users, whereas a traditional pocket may not be able to do so. The slot's capacity to expand, as described may also be efficacious for accommodating variously sized objects and hands. For example, without limitation, a user with a very large hand might only be able to insert a portion of their hand such as only their fingers but the user with large hands may still receive reliable support for their electronic device by use of this invention. However, a user with a smaller hand might be able to insert their whole hand. Those skilled in the art will recognize that, unlike pockets where a very large hand cannot fit behind the slot, the presently described slot design may accommodate a large variety of hand sizes.

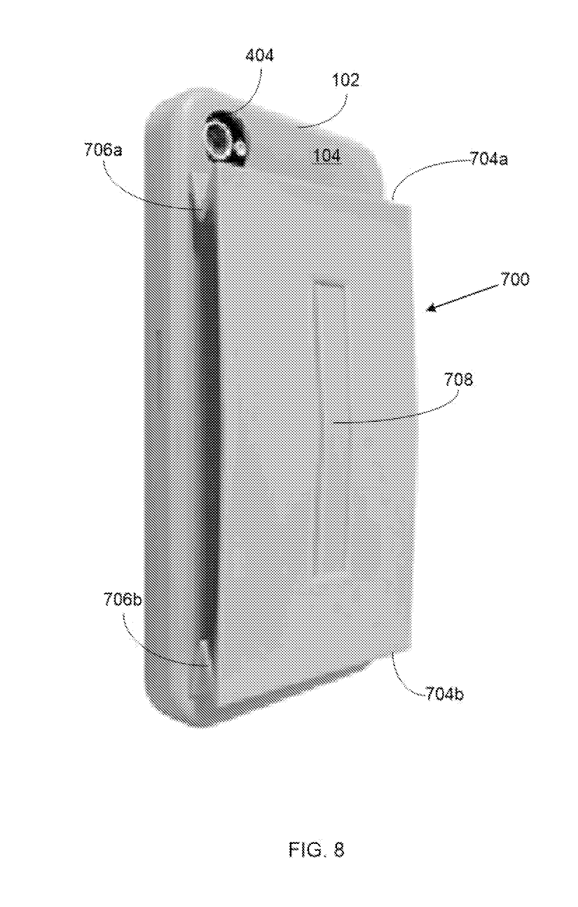

FIG. 8 illustrates a close-up rear view of an exemplary accordion seam expanded away from the outer surface of the housing. In one aspect, the accordion seam may form a resilient mechanism that facilitates expansion of the slot from the outer surface of the housing. In this manner, the slot expands and retracts through an accordion mechanism to create additional space for fitting and object, such as the hand, between the slot and the outer cover of the housing. The slot may also have a substantially resilient material composition that stretches to increase the space and retracts back against the housing when the object is removed.

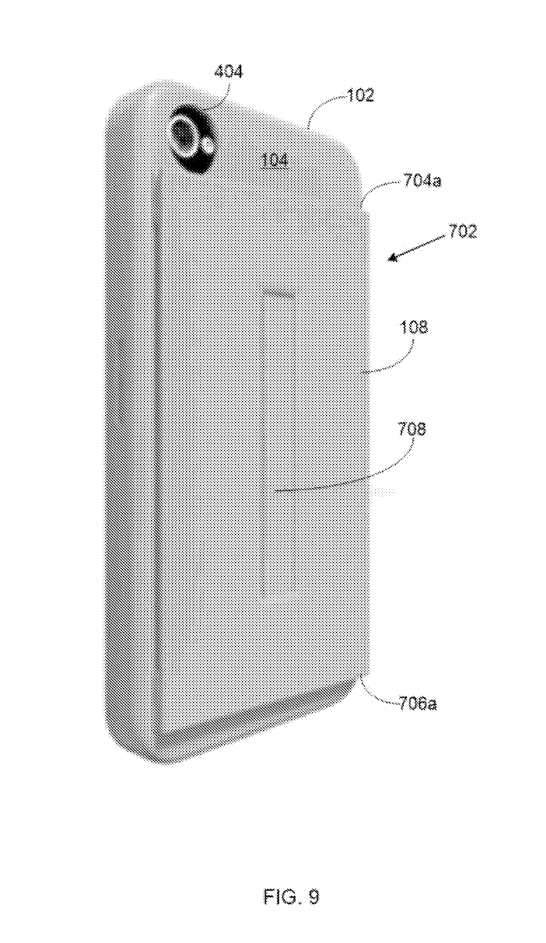

FIG. 9 illustrates a close-up rear view of an exemplary accordion seam compressed against from the outer surface of the housing. In one aspect, the slot may compresses flat against the housing. In this manner, the cover is more easily stowed. Those skilled in the art will recognize that if the slot did not lay almost flush then the housing, it would be too bulky to insert into a pocket or small purse which could make use of the cover inconvenient. Also, with the slot able to lay almost flush with the housing, the electronic device may rest flat on a table or other surface area. Finally, the slot may lie flat to ensure that the cover can be easily packaged, stacked, stored and/or shipped.

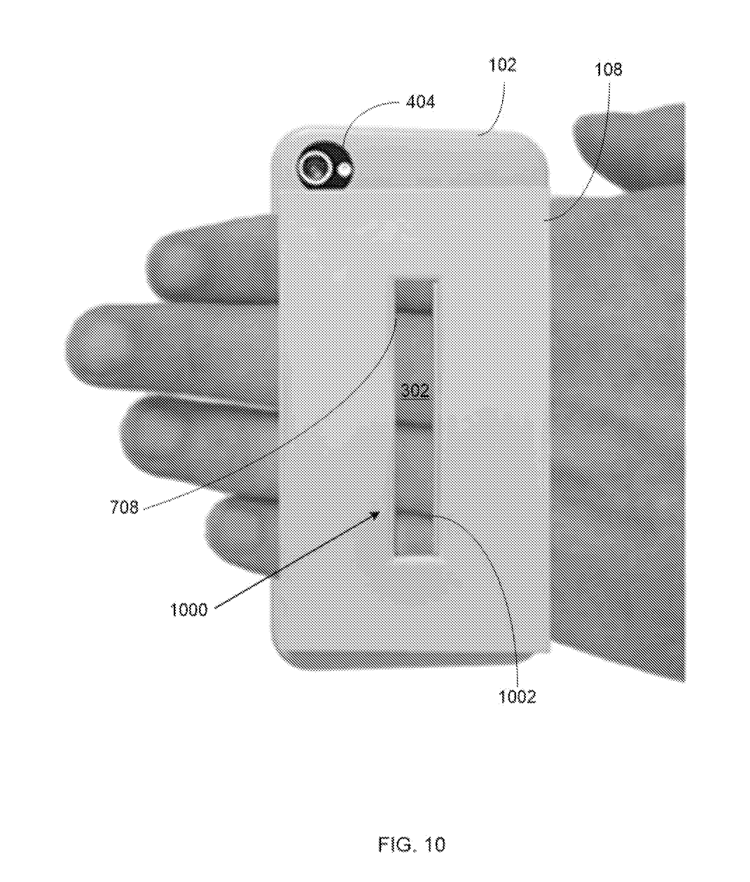

FIG. 10 illustrates a perspective view of an exemplary vent portion in an exemplary open position to enable passage of air through the slot. In one aspect, is configured to move between an open position 1000 and a closed position to selectively enable passage of the air. In this manner, the vent portion selectively enable passage of air and ventilate the object, such as a hand from behind the slot. By moving the vent portion to the open position, circulating air may engage the hand and help to keep it cool and free of sweat. This can make for a more enjoyable user experience. Another great aspect of the vent portion is it is user controlled. The user may chose not to use the vent portion and therefore keep the vent portion completely closed, the user can open the vent portion to varying degrees meaning only a partial opening, or they can completely open the vent portion.

The vent portion may include an elongated rectangular shape. However, other shapes may be possible. The vent portion is disposed to move between the open and closed positions through an easy slidable motion. In one embodiment, the vent portion slides laterally across the width of the slot. The vent portion may include a ridged edge 1002 along its length. The ridged edge is configured to facilitate sliding the vent portion between the open position and the closed position. However, in other embodiments, the vent portion may detach, or pivot between the open position and a closed position.

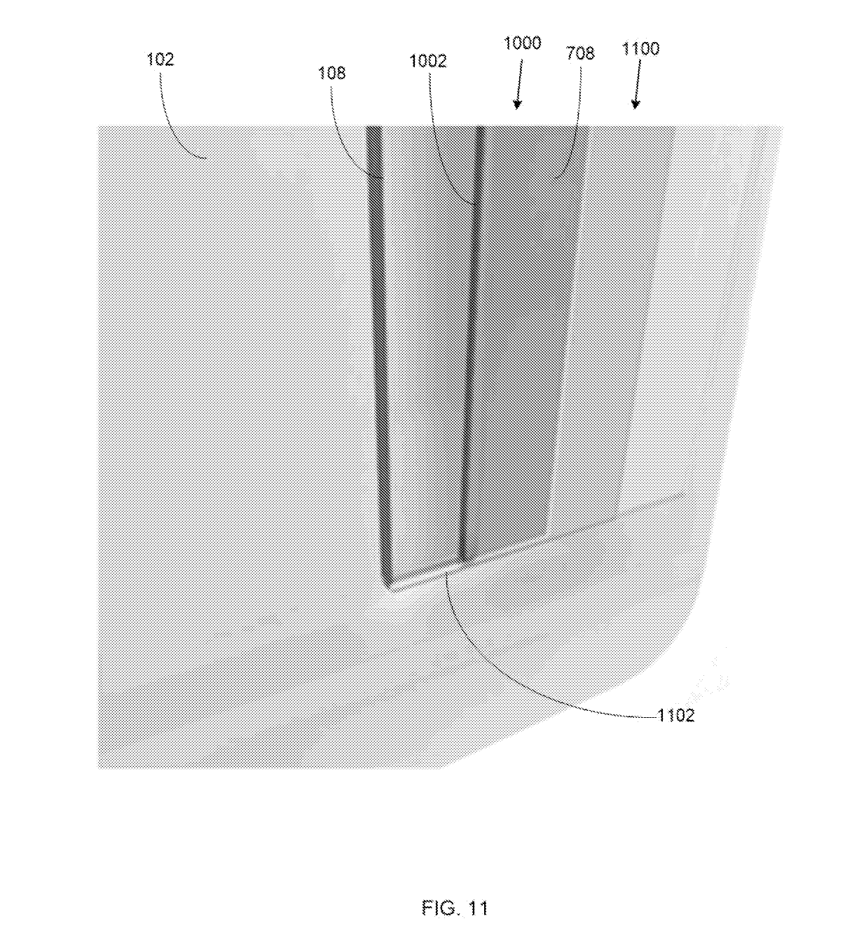

FIG. 11 illustrates a close-up view of an exemplary vent portion in an exemplary closed position and an exemplary ridged edge along the length of the vent portion, in accordance with an embodiment of the present invention. In one aspect, the open position is operable to at least partially enable passage of air through the slot. Conversely, the closed position 1100 is operable to at least partially restrict passage of air through the slot. In this manner, the hand will not be hot and uncomfortable while manipulating the communication device. As discussed above, the vent portion may slide between open and closed positions. In one embodiment, the vent portion rides a track 1102 along its edges to slide between the open and closed positions. FIG. 11 illustrates the vent portion half open. The light green area is the cover, but in a see-thru format. The vent portion is the dark green. The vent portion may slide in to a thin cavity with in the cover. In this view the door is half open.

In one alternative embodiment, the slot is detachable form the housing. In another alternative embodiment, the pair of accordion seams are integral parts, and replace the pair of ends on the slot. In yet another alternative embodiment, the housing has an integrated battery for plugging into, and powering the electronic device.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a slot on a rear end of an electronic device cover for facilitated orientation of the electronic device according to the present invention will be apparent to those skilled in the art. Various aspects of the invention have been described above by way of illustration, and the specific embodiments disclosed are not intended to limit the invention to the particular forms disclosed. The particular implementation of the slot on a rear end of an electronic device cover for facilitated orientation of the electronic device may vary depending upon the particular context or application. By way of example, and not limitation, the slot on a rear end of an electronic device cover for facilitated orientation of the electronic device described in the foregoing were principally directed to a slot in an electronic device cover that enables at least part of a hand to enter for orienting an electronic device implementations; however, similar techniques may instead be applied to orienting larger electronic devices such as laptops, computers, and robots, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A cover comprising:
a housing, said housing being configured to at least partially cover an electronic device, said housing comprising an inner surface, said inner surface being configured to engage said electronic device, said housing further comprising an outer surface, said outer surface being configured to protect said electronic device, said outer surface comprising a slot, said slot being configured to be operable to enable at least partial entry of at least a part of a hand,
said slot comprising a pair of ends,
said slot further comprising a pair of accordion seams, said pair of accordion seams being disposed to join said pair of ends of the slot with said outer surface of said housing, said pair of accordion seams being configured to articulate said slot between an expanded position and a stowed position, said expanded position being disposed to at least partially extend said slot away from said outer surface of said housing, said stowed position being disposed to at least partially compress said slot against said outer surface of said housing,
said slot further comprising a vent portion, said vent portion being disposed to move between an open position and a closed position, said open position being operable to at least partially enable passage of air through said slot, said closed position being operable to at least partially restrict passage of air through said slot.

2. The cover of claim 1, in which said cover comprises an electronic device cover.

3. The cover of claim 2, in which said electronic device comprises an iPhone, an iPad, a smart phone, or a portable electronic device.

4. The cover of claim 3, wherein said housing is fabricated from plastic.

5. The cover of claim 4, wherein said housing is operable to provide shock resistance.

6. The cover of claim 5, in which said housing comprises a plurality of apertures, said plurality of apertures being configured to align with a jack, a port, a camera lens, and a display screen.

7. The cover of claim 6, wherein said display screen is disposed to position in a front side of said cover.

8. The cover of claim 7, in which said inner surface has a rubber composition.

9. The cover of claim 8, wherein said outer surface is configured to be operable to contour to said hand.

10. The cover of claim 9, wherein said outer surface and said slot are configured to form an integral piece.

11. The cover of claim 10, wherein said slot is disposed to position in a rear side of said cover.

12. The cover of claim 11, wherein said slot is disposed to position in proximity to a bottom area of said rear side.

13. The cover of claim 12, wherein said slot is disposed to extend outwardly from said outer surface.

14. The cover of claim 13, wherein said slot is configured to form a balancing pivot point while retaining said electronic device.

15. The cover of claim 14, in which said pair of accordion seams are disposed to join with said outer surface.

16. The cover of claim 15, in which said vent portion has an elongated shape.

17. The cover of claim 16, in which said vent portion comprises a ridged edge.

18. The cover of claim 17, wherein said ridged edge is configured to facilitate sliding said vent portion between said open position and said closed position.

19. A cover comprising:
means for at least partially enclosing;
means for enabling at least partial entry inside said enclosing means;
means for at least partially expanding said entry means;
means for at least partially enabling passage of air through said entry means; and
means for manipulating said enclosing means;

20. A cover consisting of:
a housing, said housing comprising plastic, said housing comprising a plurality of apertures, said plurality of apertures being configured to align with a jack, a port, a camera lens, and a display screen, said display screen being disposed to position in a front side of said cover, said housing being configured to at least partially cover an electronic device, said electronic device comprising an iPhone, an iPad, or a smart phone, said housing comprising an inner surface, said inner surface being configured to engage said electronic device, said inner surface comprising rubber, said rubber being configured to grip said electronic device, said housing further comprising an outer surface, said outer surface being configured to protect said electronic device, said outer surface comprising a slot, said slot being configured to be operable to enable at least partial entry of at least a part of a hand, said slot being disposed to extend outwardly from said outer surface, said slot being configured to fit snugly on said hand, said slot being disposed to position on a rear side of said cover, said slot being disposed to position in proximity to a bottom area of said rear side,
said slot comprising a pair of ends,
said slot further comprising a pair of accordion seams, said pair of accordion seams being disposed to join said pair of ends of the slot with said outer surface of said housing, said pair of accordion seams being configured to articulate said slot between an expanded position and a stowed position, said expanded position being disposed to at least partially extend said slot away from said outer surface of said housing, said stowed position being disposed to at least partially compress said slot against said outer surface of said housing,
said slot further comprising a vent portion, said vent portion being disposed to move between an open position and a closed position, said open position being operable to at least partially enable passage of air through said slot, said closed position being operable to at least partially restrict passage of air through said slot.
